(19) United States
(12) Patent Application Publication
(10) Pub. No.: US 2011/0299090 A1
(43) Pub. Date: Dec. 8, 2011

(54) REAL-TIME INTERFEROMETER

(75) Inventor: Nobuaki UEKI, Saitama (JP)

(73) Assignee: FUJIFILM CORPORATION, Tokyo (JP)

(21) Appl. No.: 13/153,904

(22) Filed: Jun. 6, 2011

(30) Foreign Application Priority Data
Jun. 7, 2010 (JP) 2010-130345

(51) Int. Cl. G01B 9/02

(52) U.S. Cl. 356/491

(57) ABSTRACT

A detour unit splits a light beam from a light source unit into first and second beams and makes the first beam travel longer than the second beam by a predetermined optical distance, and then combines the first and second beams into a single combined light beam. In the detour unit, a first λ/2 plate is disposed on an optical path of the first beam. A second μ/2 plate is disposed on an optical path of the second beam. Directions of optical axes of the first and second λ/2 plates are different from each other by 45 degrees. A λ/4 plate is disposed on an optical path between the detour unit and a beam expanding unit. Thereby, the first and second beams are converted into two circularly polarized beams having opposite rotation directions, respectively.

### BACKGROUND OF THE INVENTION

1. Field of the invention

The present invention relates to a real-time interferometer for measuring a shape of a sample surface or the like with high accuracy.

2. Description Related to the Prior Art

A real-time interferometer with high accuracy is known (see Japanese Patent No. 2821685). This interferometer concurrently obtains sets of interference fringes that carry wavefront information of a sample surface and are mutually out of phase. Thereby, high accuracy of the order of equal to or less than one several hundredths of a wavelength of a measuring beam is achieved.

With the use of wave plates, the interferometer converts a reference beam and a sample beam (a beam reflected by the sample surface) into left and right circularly polarized beams. Interference light, composed of the reference beam and the sample beam, is split into three components by the interferometer. The three components pass through three polarizers, respectively. The polarizers are different in directions of transmission axes by 45 degrees. Thereby, three sets of interference fringes that are mutually out of phase by 90 degrees are imaged at the same time. Analysis of the three sets of interference fringes allows the real-time interferometry with high accuracy.

In the interferometer disclosed in the Japanese Patent No. 2821685, before a beam is incident on a wave plate, the beam has been expanded in diameter to the size substantially the same as that of an area to be irradiated with the beam. Accordingly, it is necessary to use a large sized wave plate that covers the entire beam diameter. Because the beam expanded in diameter passes through the wave plate, wavefront distortion is likely to occur. This may have a detrimental effect on a measurement result.

### SUMMARY OF THE INVENTION

An object of the present invention is to provide a real-time interferometer for performing real-time optical interferometry with higher accuracy while preventing wavefront distortion caused when a reference beam and a sample beam pass through an optical element unit for conversion into two different circularly polarized beams.

To achieve the above and other objects, a real-time interferometer according to the present invention includes a light source unit, a detour unit, a beam expanding unit, a reference surface, an interference light dividing element, two or more polarizers, two or more image sensors, an optical path adjuster, an optical element unit for conversion into circularly polarized beams, and an analyzing unit. The light source unit outputs a low coherent light beam composed of a linearly polarized beam. The detour unit splits the light beam from the light source unit into a first beam and a second beam and makes the first beam travel longer than the second beam by a predetermined optical distance. Then the detour unit combines the first and second beams into a single combined light beam and outputs the combined light beam. The beam expanding unit expands a beam diameter of the combined light beam from the detour unit. The reference surface separates the combined light beam with an expanded beam diameter into a reference beam and a measuring beam and outputs the measuring beam to a sample surface. The reference beam is composed of a first beam component that has passed through an optical path of the first beam. The measuring beam is composed of a second beam component that has passed through an optical path of the second beam. The interference light dividing element divides interference light into two or more interference light components. The interference light is composed of the reference beam and a sample beam that is the measuring beam reflected back from the sample surface. The two or more polarizers are different in directions of transmission axes. The polarizers are disposed on optical paths of the interference light components, respectively. The two or more image sensors take images of two or more sets of interference fringes at the same time, respectively. The interference light components passed through the polarizers form the sets of interference fringes, respectively. The sets of interference fringes are mutually out of phase. The optical path adjuster adjusts an optical path difference between the reference beam and the sample beam. The optical element unit for conversion into circularly polarized beams is composed of two or more optical elements disposed on two or more optical paths before the beam expanding unit. The optical element unit converts the first beam into a first circularly polarized beam and the second beam into a second circularly polarized beam. The first and second circularly polarized beams have opposite rotation directions. The analyzing unit analyzes a shape of the sample surface real-time based on the images of the sets of interference fringes.

It is preferable that the light beam outputted from the light source unit is a pulsed light beam, and the real-time interferometer further includes a measurement timing controller for adjusting output timing of the pulsed light beam and imaging timing of the imaging unit.

It is preferable that the optical element unit includes first and second λ/2 plates and a λ/4 plate. It is preferable that the first λ/2 plate is disposed on the optical path of the first beam in the detour unit. It is preferable that the second λ/2 plate is disposed on the optical path of the second beam in the detour unit. It is preferable that directions of optical axes of the first and second λ/2 plates are different from each other by 45 degrees. It is preferable that the λ/4 plate is disposed on an optical path between the detour unit and the beam expanding unit.

According to the real-time interferometer of the present invention, the optical element unit for conversion into circularly polarized beams is composed of the optical elements disposed on the optical paths before the beam expanding unit. The optical element unit converts the first and second beams split in the detour unit into the first and second circularly polarized beams having opposite rotation directions. In other words, the reference beam and the sample beam are the first and second circularly polarized beams having opposite rotation directions, respectively. The interference light dividing element in the imaging unit divides the interference light, composed of the reference beam and the sample beam, into two or more interference light components. The interference light components pass through the polarizers, respectively. The polarizers differ in the directions of the transmission axes. Then the interference light components are incident on the image sensors, respectively. Thereby, the interference light components form the sets of interference fringes on the image sensors, respectively. The sets of interference fringes being formed are mutually out of phase. Analysis of the sets of interference fringes allows the real-time measurement of the sample surface or the like.

Because the optical elements of the optical element unit for conversion into circularly polarized beams are disposed on the optical paths before the beam expanding unit, the beam passing through the optical element unit has a small diameter. Accordingly, the size of the optical element unit can be reduced. Because the beam with the small beam diameter traverses the optical element unit, wavefront distortion during the traverse is prevented. Thus, the real-time optical interferometry is performed with high accuracy.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic view of a real-time interferometer;

FIG. 2 is a block diagram showing a configuration of an analysis control device shown in FIG. 1; and

FIG. 3 shows output timing of a pulsed light beam.

### DESCRIPTION OF THE PREFERRED EMBODIMENTS

### (Configuration of Apparatus)

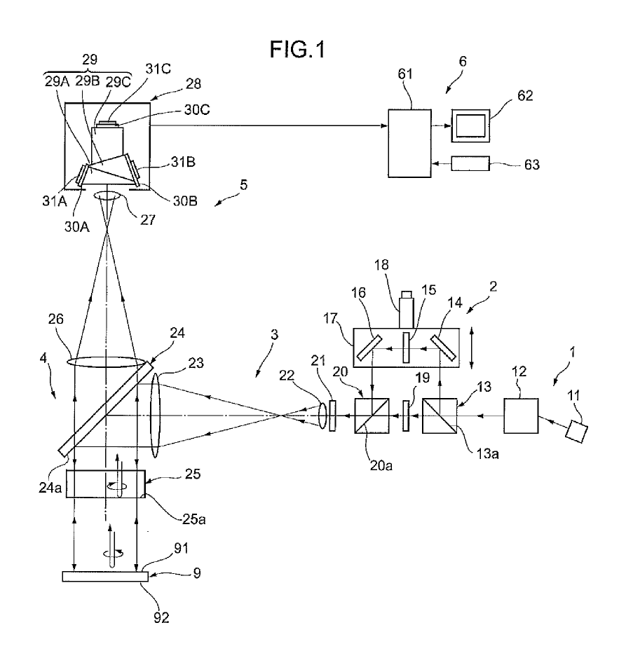

In FIG. 1, a real-time interferometer (hereinafter simply referred to as interferometer) measures a shape of a first surface 91 (upper surface in FIG. 1) of a sample 9 that is a transparent flat plate having parallel first and second surfaces 91 and 92. The interferometer is provided with a light source unit 1, a detour unit 2, a beam expanding unit 3, an interference light generating unit 4, an imaging unit 5, and an analysis control unit 6.

The light source unit 1 is composed of a low coherent light source 11 and an AOM (acousto-optic modulator) 12. In this embodiment, the low coherent light source 11 is an SLD (superluminescent diode) with a linear polarizer. The low coherent light source 11 outputs a low coherent light beam composed of a linearly polarized beam. The output light beam has a coherence length (for example, of the order of 30 μm) shorter than an optical distance twice as large as a thickness (design value) of the sample 9. The AOM 12 deflects the light beam, outputted from the low coherent light source 11, using an acousto-optic effect. Thereby, the AOM 12 outputs the light beam as a pulsed light beam emitted only for an extremely short time, for example, 10 microseconds (μs) at every predetermined timing to the detour unit 2 located at the lower left in FIG. 1.

The detour unit 2 is composed of a beam splitter 13, a reflection mirror 14, a first λ/2 plate 15, a reflection mirror 16, an installation stage 17, a detour distance adjuster 18, a second λ/2 plate 19, a beam splitter 20, and a λ/4 plate 21. A non-polarizing beam splitting surface or interface 13a of the beam splitter 13 splits a light beam incident thereon from the light source unit 1 into a first beam and a second beam. The beam splitting surface 13a directs the first beam upward and the second beam to the left in FIG. 1. The detour unit 2 makes the first beam travel longer than the second beam by a predetermined optical distance (hereinafter referred to as a detour distance). The second beam passes through the beam splitter 13, the second λ/2 plate 19, and the beam splitter 20 in this order. On the other hand, the first beam is incident on the beam splitter 20 from the beam splitter 13, through the reflection mirror 14, the first λ/2 plate 15, and the reflection mirror 16. Thus, the first beam makes a detour relative to the second beam. The first and second beams are combined together at a non-polarizing beam splitting surface or interface 20a of the beam splitter 20. The combined light beam is outputted to the beam expanding unit 3 through the λ/4 plate 21.

The first λ/2 plate 15 and the second λ/2 plate 19 are disposed with their optical axes (fast axes) rotated by 45 degrees from each other. Thereby, a polarization direction (a direction of a plane of vibration) of the first beam passed through the first λ/2 plate 15 and a polarization direction (a direction of a plane of vibration) of the second beam passed through the second λ/2 plate 19 are changed to intersect each other orthogonally. A direction of an optical axis (a fast axis) of the λ/4 plate 21 differs from a polarization direction of each of the incident first and second beams by 45 degrees. Thereby, the λ/4 plate 21 converts a first beam component (composed of the first beam) of the incident light beam into a first circularly polarized beam, and a second beam component (composed of the second beam) of the incident light beam into a second circularly polarized beam. The first and second circularly polarized beams have opposite rotation directions. The λ/4 plate 21 outputs the first and second circularly polarized beams to the beam expanding unit 3.

As described in this embodiment, the first λ/2 plate 15, the second λ/2 plate 19, and the λ/4 plate 21 (hereinafter may referred to as wave plates) for obtaining two circularly polarized beams are disposed in the detour unit 2 and an optical path between the detour unit 2 and the beam expanding unit 3. Each wave plate is disposed in a position where a beam passing through the wave plate has a small beam diameter. This allows reduction in size of each wave plate. Because the beam with a small diameter traverses each of the wave plates, wavefront distortion of the light beam during the traverse is prevented.

The installation stage 17 supports the reflection mirror 14, the first λ/2 plate 15, and the reflection mirror 16. The detour distance adjuster 18 moves the reflection mirror 14, the first λ/2 plate 15, and the reflection mirror 16 integrally through the installation stage 17 in an up-and-down direction in FIG. 1. Thereby, the detour distance adjuster 18 adjusts a detour distance of the first beam relative to the second beam in the detour unit 2.

The beam expanding unit 3 is composed of a condenser lens 22 and a collimator lens 23. The condenser lens 22 gathers the light beams, outputted from the detour unit 2, and then disperses the light beams to expand the beam diameter. Then, the collimator lens 23 collimates the light beams expanded in diameter, and outputs the collimated light beams to the left in FIG. 1.

The interference light generating unit 4 is composed of a half mirror 24 and a reference plate 25. A non-polarizing beam splitting surface 24a of the half mirror 24 reflects the light beam from the beam expanding unit 3 to the reference plate 25. A reference surface 25a of the reference plate 25 separates or splits the light beam into a reference beam and a measuring beam. The reference surface 25a retroreflects the reference beam to the half mirror 24 and outputs the measuring beam to the sample 9. The reference surface 25a combines the reference beam and a sample beam that is the measuring beam reflected back from the sample 9. In this embodiment, the reference beam is composed of the first beam component that has passed through an optical path of the first beam in the detour unit 2. The sample beam is composed of the second beam component that has passed through the optical path of the second beam in the detour unit 2 and then is retroreflected from the first surface 91. The detour distance of the first beam relative to the second beam is adjusted in the detour unit 2 so as to make the reference beam and the sample beam interfere with each other.

The imaging unit 5 is composed of a condenser lens 26, an imaging lens 27, and an imaging camera 28. The imaging camera 28 takes an image of the interference fringes formed by the interference light composed of the reference beam and the sample beam (the reflected measuring beam) . The imaging camera 28 is composed of a beam splitting prism 29, three polarizers 30A, 30B, and 30C, and three image sensors 31A, 31B, and 31C. The beam splitting prism 29 is composed of three prisms 29A, 29B, and 29C for splitting (dividing) the interference light, incident from the imaging lens 27, into three interference light components. The polarizers 30A, 30B, and 30C are disposed at light output ends of the prisms 29A, 29B, and 29C, respectively. Directions of transmission axes of the polarizers 30A, 30B, and 30C are different from each other. The image sensors 31A, 31B, and 31C are disposed behind the polarizers 30A, 30B, and 30C, respectively.

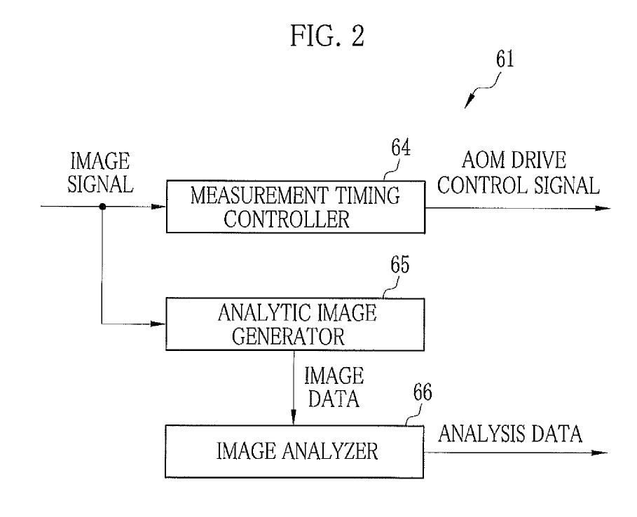

The analysis control unit 6 is provided with an analysis control device 61 composed of a computer or the like, a monitor device 62 for displaying an interference fringe image or the like, and an input device 63 for performing various input operations to the analysis control device 61. As shown in FIG. 2, the analysis control device 61 is provided with a measurement timing controller 64, an analytic image generator 65, and an image analyzer 66 that are constituted of a CPU installed in the computer, storage such as a hard disk, and a program or the like stored in the storage, and the like.

The measurement timing controller 64 synchronizes timing at which the pulsed light beam from the AOM 12 (see FIG. 1) is incident on the detour unit 2 and the imaging timing at which the imaging camera 28 takes the interference fringe image. Based on an image signal, outputted as a video signal from the imaging camera 28, the measurement timing controller 64 outputs an AOM drive control signal to the AOM 12 to control the AOM 12 such that the pulsed light beam from the AOM 12 is incident on the detour unit 2 at predetermined timing within accumulation periods of the image sensors 31A, 31B, and 31C.

Based on the image signals obtained by the image sensors 31A, 31B, and 31C of the imaging camera 28, the analytic image generator 65 generates analytic interference fringe images, respectively. The analytic interference fringe images are used for analysis of the shape of the first surface 91 of the sample 9. The analytic image generator 65 outputs image data of the analytic interference fringe images to the image analyzer 66. Based on the image data of the analytic interference fringe images, the image analyzer 66 measures or calculates the shape of the first surface 91 of the sample 9 and generates analysis data.

Hereinafter, an operation of the interferometer is described. Note that alignment has been completed before the measurement.

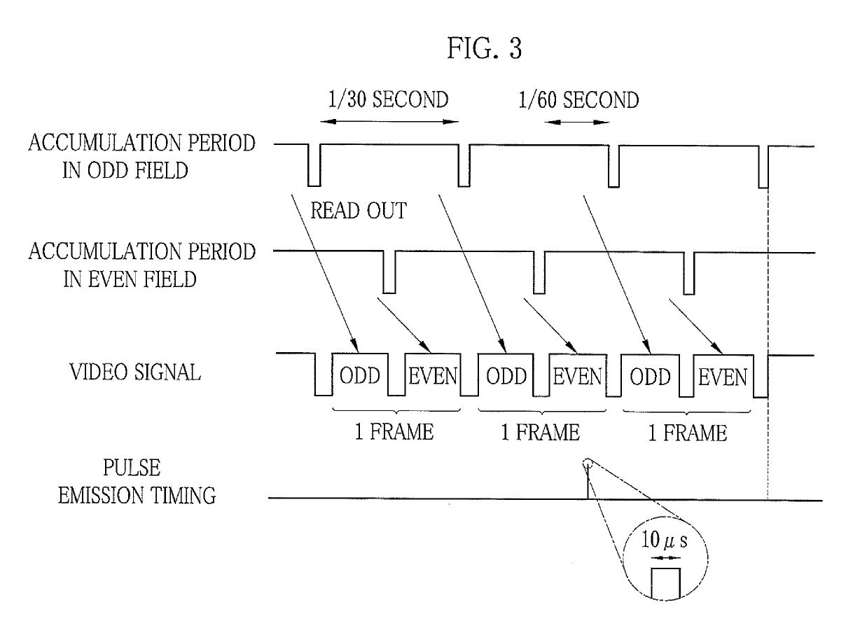

### (Measurement Operation)

<1> As shown in FIG. 1, the AOM 12 changes the direction of the linearly polarized beam, outputted from the low coherent light source 11, at predetermined timing, and outputs the pulsed light beam to the detour unit 2. The measurement timing controller 64 adjusts the timing to output the pulsed light beam to the detour unit 2 in accordance with imaging timing of the imaging camera 28 as shown in FIG. 3, for example. In FIG. 3, the image sensors 31A, 31B, and 31C of the imaging camera 28 transfer signal charges using an interline transfer method, and the signal charges are read out using an interlace method of NTSC standard, by way of example.

In the example shown in FIG. 3, in each of the image sensors 31A, 31B, and 31C, a charge accumulation period (a light receiving period) in each of an odd field and an even field is 1/30 second.

The charge accumulation periods of the odd and even fields overlap one another by 1/60 second. The charge is read out from the odd field and the even field alternately and repeatedly. Each frame is made up of a pair of odd and even fields. For example, the pulsed light beam is generated at 10 μs pulse width only once substantially in the middle of the overlapped charge accumulation periods of the odd and even fields. Accordingly, the charge is concurrently accumulated in both the odd and even fields in one frame only during the emission of the pulsed light beam. Thereby, influence of vibration in interferometer during imaging of the interference fringe image is eliminated, allowing on-line or in-process measurement.

<2> The beam splitting surface 13a of the beam splitter 13 splits the pulsed light beam incident on the detour unit 2 into the first beam and the second beam. The beam splitting surface 13a directs the first beam to the reflection mirror 14 and the second beam to the second λ/2 plate 19.

<3> The first beam is reflected off the reflection mirror 14 at a right angle and then incident on the first λ/2 plate 15. The first λ/2 plate 15 defines or sets the polarization direction of the first beam. Then, the first beam is incident on the beam splitter 20 through the reflection mirror 16.

<4> The second beam, on the other hand, is incident on the second λ/2 plate 19. The second λ/2 plate 19 defines or sets the polarization direction of the second beam perpendicular to the polarization direction of the first beam passed through the first λ/2 plate 15. Then, the second beam is incident on the beam splitter 20.

<5> The first beam and the second beam incident on the beam splitter 20 are combined together into the single combined light beam at the beam splitting surface 20a, and then is outputted to the λ/4 plate 21.

<6> When the light beam passes though the λ/4 plate 21, a beam component composed of the first beam is converted into the first circularly polarized beam, and a beam component composed of the second beam is converted into the second circularly polarized beam. The first and second circularly polarized beams rotate in the opposite directions. Then, the light beam is outputted to the beam expanding unit 3.

<7> The light beam outputted from the λ/4 plate 21 to the beam expanding unit 3 is incident on the condenser lens 22. The condenser lens 22 gathers and then disperses the incident light beams to expand the incident light beams in diameter. Then, the collimator lens 23 collimates the light beams expanded in diameter. The collimated light beams are incident on the interference light generating unit 4.

<8> The collimated light beam is incident on the reference plate 25 through the beam splitting surface 24a of the half mirror 24. At the reference surface 25a, the light beam is split into the reference beam and the measuring beam. The reference beam is retroreflected to the half mirror 24. The measuring beam is outputted to the sample 9.

<9> A part of the measuring beam outputted to the sample 9 is reflected back from the first and second surfaces 91 and 92 of the sample 9 and returns to the reference plate 25. In this embodiment, as described above, the reference beam is composed of the first beam component (the first circularly polarized beam) that has passed through the optical path of the first beam in the detour unit 2. The sample beam is the measuring beam retroreflected by the first surface 91 and composed of the second beam component (the second circularly polarized beam) that has passed through the optical path of the second beam.

<10> The reference beam and the sample beam are combined together on the reference surface 25a. The interference between the reference beam and the sample beam does not occur if an optical path difference between the reference beam (traveling from the low coherent light source 11, through the AOM 12, the beam splitting surface 13a, the reflection mirror 14, the first λ/2 plate 15, the reflection mirror 16, the beam splitting surface 20a, the λ/4 plate 21, the condenser lens 22, the collimator lens 23, and the beam splitting surface 24a, to the reference surface 25a in FIG. 1) and the sample beam (traveling from the low coherent light source 11, through the AOM 12, the beam splitting surface 13a, the second λ/2 plate 19, the beam splitting surface 20a, the λ/4 plate 21, the condenser lens 22, the collimator lens 23, the beam splitting surface 24a, the reference surface 25a, and the first surface 91, to the reference surface 25a in FIG. 1) is longer than the coherence length of the low coherent light being used.

<11> The detour distance of the first beam relative to the second beam in the detour unit 2 is adjusted such that the optical path difference between the reference beam and the sample beam is equal to or shorter than the coherence length of the low coherent light. To adjust the detour distance, the detour distance adjuster 18 integrally moves the reflection mirror 14, the first λ/2 plate 15, and the reflection mirror 16, all supported by the installation stage 17.

<12> When the optical path difference between the reference beam and the sample beam is adjusted to be equal to or shorter than the coherence length of the low coherent light, the reference beam and the sample beam form the interference light. The interference light is incident on the imaging camera 28 through the half mirror 24, the condenser lens 26, and the imaging lens 27.

<13> The beam splitting prism 29 splits the interference light incident on the imaging camera 28 into three interference light components that pass through the prisms 29A, 29B, and 29C, respectively. Then, the three interference light components pass through the polarizers 30A, 30B, and 30C, respectively. The polarizers 30A, 30B, and 30C are disposed at the light output ends of the prisms 29A, 29B, and 29C, respectively. Thereafter, the three interference light components form the three sets of interference fringes on the image sensors 31A, 31B, and 31C, respectively. The image sensors 31A, 31B, and 31C are disposed behind the polarizers 30A, 30B, and 30C, respectively. The image sensors 31A, 31B, and 31C take images of the interference fringes, respectively, and at the same time.

<14> The directions of the transmission axes of the three polarizers 30A, 30B, and 30C are different from each other. For example, the direction of the transmission axis of the polarizer 30B is rotated 45 degrees relative to that of the polarizer 30A. The direction of the transmission axis of the polarizer 30C is rotated 90 degrees relative to that of the polarizer 30A. Thereby, the sets of interference fringes formed on the image sensors 31A, 31B, and 31C are mutually out of phase by 90 degrees.

<15> Each of the image sensors 31A, 31B, and 31C outputs image data, of the interference fringe image, as the image signal (the video signal). Thereby, the analytic image generator 65 generates three analytic interference fringe images that are mutually out of phase.

<16> Based on the image data of the three analytic interference fringe images, the image analyzer 66 analyzes the shape of the first surface 91 of the sample 9. A known phase shift method can be used for the analysis.

While the reference beam and the sample beam are made to interfere with each other to form interference fringes, the detour distance of the first beam relative to the second beam in the detour unit 2 may be finely adjusted. Every time the detour distance is finely adjusted, the three sets of interference fringes formed on the image sensors 31A, 31B, and 31C are imaged and the contrasts thereof (or modulations thereof) are obtained, respectively. Here, based on a relation between the optical path difference, between the first and second beams in the detour unit 2, and the contrast of the interference fringes, the optical path difference, between the first and second beams in the detour unit 2, at which the contrast is maximum is calculated. Thereby, an optical distance between the reference surface 25a and the first surface 91 of the sample 9 is obtained. Further, using this technique, a difference in level on the first surface 91, being the sample surface, can be obtained.

According to the interferometer of this embodiment, the three sets of interference fringes that are mutually out of phase are obtained at the same time, allowing a real-time measurement with high accuracy using a phase shifting method. A technique for concurrently obtaining two or more sets of interference fringes that are out of phase is described in Japanese Patent No. 2821685, for example.

The interferometer uses the low coherent light having the coherence length shorter than the optical distance (twice as long as the thickness of the sample 9) and is provided with the detour unit 2. The detour unit 2 adjusts the optical path difference between the reference beam and the sample beam such that the reference beam and the sample beam interfere with each other. This prevents the measuring beam, reflected back from the second surface 92 of the sample 9, from interfering with the reference beam. A technique for preventing undesired interference caused by the measuring beam reflected from the back surface of the sample is described in, for example, Japanese Patent No. 3795191.

The embodiment of the present invention is described as above. The present invention, however, is not limited to the above. Various changes and modifications are possible in the present invention and may be understood to be within the present invention. For example, in the above embodiment, λ/2 plates (the first λ/2 plate 15 and the second λ/2 plate 19) are disposed on the optical paths of the first and second beams, respectively. Alternatively, the λ/2 plate may be disposed on only one of the above optical paths. Thereby, the polarization directions of the first and second beams become orthogonal to each other.

In the above embodiment, the AOM 12 is used for converting the light beam, outputted from the low coherent light source (SLD) 11, into the pulsed light beam. Alternatively, an optical chopper may be used. It is also possible to use a pulsed laser. For example, a pulsed laser beam may be outputted from a femtosecond pulse laser through an optical fiber. Thereby, a low coherent pulsed laser beam is obtained.

In the above embodiment, in the detour unit 2, the detour distance of the first beam is increased or decreased relative to the second beam to adjust the optical path difference between the reference beam and the sample beam. Alternatively or in addition, the optical distance between the reference surface 25a and the first surface 91 of the sample 9 may be increased or decreased to adjust the optical path difference between the reference beam and the sample beam.

In the above embodiment, the interferometer is configured to measure the shape of a flat surface (the first surface 91 of the sample 9). The present invention is also applicable to measurements of a spherical surface and a radius of curvature thereof.

If a sample surface has a large area or has large undulations, the measurement may be performed on a region-by-region basis, and then measurement results (analysis data) may be put together using, for example, a synthetic aperture method.

What is claimed is:

1. A real-time interferometer comprising:
alight source unit for outputting a low coherent light beam composed of a linearly polarized beam;
a detour unit for splitting the light beam from the light source unit into a first beam and a second beam and making the first beam travel longer than the second beam by a predetermined optical distance and then combining the first and second beams into a single combined light beam and outputting the combined light beam;
a beam expanding unit for expanding a beam diameter of the combined light beam from the detour unit;
a reference surface for separating the combined light beam with an expanded beam diameter into a reference beam and a measuring beam and outputting the measuring beam to a sample surface, the reference beam being composed of a first beam component that has passed through an optical path of the first beam, the measuring beam being composed of a second beam component that has passed through an optical path of the second beam;
an interference light dividing element for dividing interference light into two or more interference light components, the interference light being composed of the reference beam and a sample beam that is the measuring beam reflected back from the sample surface;
two or more polarizers different in directions of transmission axes, the polarizers being disposed on optical paths of the interference light components, respectively;
two or more image sensors for taking images of two or more sets of interference fringes at the same time, respectively, the interference light components passed through the polarizers forming the sets of interference fringes, respectively, the sets of interference fringes being mutually out of phase;
an optical path adjuster for adjusting an optical path difference between the reference beam and the sample beam;
an optical element unit for conversion into circularly polarized beams, the optical element unit being composed of two or more optical elements disposed on two or more optical paths before the beam expanding unit, the optical element unit converting the first beam into a first circularly polarized beam and the second beam into a second circularly polarized beam, the first and second circularly polarized beams having opposite rotation directions; and
an analyzing unit for analyzing a shape of the sample surface real-time based on the images of the sets of interference fringes.

2. The real-time interferometer of claim 1, wherein the light beam outputted from the light source unit is a pulsed light beam, and the real-time interferometer further includes a measurement timing controller for adjusting output timing of the pulsed light beam and imaging timing of the imaging unit.

3. The real-time interferometer of claim 1, wherein the optical element unit includes:
a first λ/2 plate disposed on the optical path of the first beam in the detour unit;
a second λ/2 plate disposed on the optical path of the second beam in the detour unit, directions of optical axes of the first and second λ/2 plates being different from each other by 45 degrees; and
a λ/4 plate disposed on an optical path between the detour unit and the beam expanding unit.
